(19) United States
(12) Patent Application Publication
(10) Pub. No.: US 2026/0109451 A1
(43) Pub. Date: Apr. 23, 2026

(54) METHOD AND SYSTEM FOR ENHANCING PROPULSION EFFICIENCY OF ROTATING AERO AND HYDRO DYNAMIC BLADES THROUGH VORTEX-INDUCED FLOW MODIFICATION

(71) Applicant: DELTA BURN PTE LTD, Singapore (SG)

(72) Inventor: Peter IRELAND, Singapore (SG)

(21) Appl. No.: 19/160,369

(22) PCT Filed: Oct. 4, 2024
(86) PCT No.: PCT/AU2024/051049

§ 371 Date: Aug. 27, 2025

(30) Foreign Application Priority Data
Oct. 5, 2023 (AU) 2023903199

(51) Int. Cl. B64C 11/18; B63H 1/28; B64C 23/06

(52) U.S. Cl. CPC B64C 11/18; B63H 1/28; B64C 23/06

(57) ABSTRACT

A vortex inducer is applied to the pressure face of a propulsion rotor blade. The vortex inducer defines an aft face located forward of the trailing edge of the blade. In operation, the vortex inducer generates a primary vortex behind its apex, which induces a counterrotating secondary vortex through viscous coupling at the trailing edge. The secondary vortex accelerates and deflects the suction face wake, enhancing overall blade performance. The system is applicable to propellers, helicopter rotors, prop-rotors, fan blades, and marine propellers.

### FIELD OF INVENTION

The field of the invention relates to methods and processes for enhancing the efficiency of propulsion systems, particularly those involving propulsive actuating disks such as aircraft and marine propellers, helicopter rotors, prop-rotors, and turbofan engines. The invention specifically addresses improvements in aerodynamic and hydrodynamic performance through modifications to the flow characteristics around rotor blades.

### BACKGROUND

Efficiency is a fundamental parameter in propulsion systems, particularly in aviation and marine applications, where the objective is to maximise the useful work produced relative to the energy expended. Propeller technology has been extensively developed since the late 1800s and thoroughly researched since the early 1900s, making it a mature field with efficiencies approaching theoretical limits through iterative, incremental improvements. Turbomachinery has similarly undergone extensive advancements, with gains in thermodynamic efficiency largely confined to developments in material properties and thermal barrier coatings. Current combustion efficiency in turbomachinery is nearing its practical limits, constrained by material tolerances that restrict further increases in peak combustion temperatures, and any temperature increases exacerbate the production of NOx emissions, raising environmental concerns.

Propulsion is fundamentally governed by Newton's laws, where motion is achieved through the acceleration of mass, translating to a mass flow rate and a differential velocity. For propellers, rotors, and prop-rotors, this involves processing a volume of fluid (air or liquid) through the actuator disk (propeller area), increasing the exit velocity, which eventually recovers to free stream conditions. The propeller operates as a series of blade sections interacting with the fluid, where each section contributes lift and drag forces, with the combined forces generating thrust and required torque. The blade elements create forces that affect the aerodynamic performance, including lift, drag, and pitching moment, all relative to the axis of rotation, which in turn determine the propeller's overall thrust and efficiency.

Turbofan engines introduce additional complexities, particularly regarding mass flow choking within the bypass duct, which limits both pressure and achievable velocities behind the fan stage. Extensive research has focused on modifying trailing edge conditions of airfoil sections to enhance aerodynamic performance, including devices such as the Gurney tab, Lift Enhancing Tab, MiTes, or wicker bill. The Gurney tab, typically applied perpendicularly to the trailing edge of an airfoil, modifies flow conditions by inducing vortices that enhance lift but generally increase drag, particularly at moderate angles of attack. While the Gurney tab can stabilise flow and improve performance at high angles of attack, its associated vortex shedding often induces periodic flow instabilities, such as the Von Karman vortex street, which can lead to increased vibration and aerodynamic noise. Academic studies have consistently observed that these tabs tend to adversely affect the lift-to-drag ratio, especially under transonic flow conditions.

### SUMMARY OF THE INVENTION

There is provided herein a system and method to enhance the efficiency of propulsion rotor blades, such as those used in propellers, rotors, prop-rotors, and fan blades. The system employs a vortex inducer applied to the pressure face of the blade, positioned forward of the trailing edge. This inducer generates a complex fluid flow structure involving primary and secondary vortices, which interact to modify the flow over the suction face of the blade. The resulting flow structure reduces drag while increasing lift, leading to improved performance of the blade.

The secondary vortex accelerates and deflects the wake flow on the suction face, redirecting it away from the trailing edge and enhancing the aerodynamic efficiency of the blade. At low velocities, this effect may significantly reduce vibration. When the flow over the suction face reaches supersonic speeds, the inducer mitigates normal shocks by inducing a Prandtl-Meyer expansion fan, thereby replacing the shock with a smooth expansion that increases exit flow velocity and aligns it closer to the axial direction. This adjustment leads to improved thrust and reduced torque requirements at a given RPM, enhancing the overall efficiency of the propulsion system.

Unlike prior systems, where expansion fans rely on a mechanical surface behind the expansion point, this approach uses a fluid flow feature without a physical surface influencing the exit flow conditions. Also, as a result, icing is mitigated since no mechanical surface exists behind the expansion point where icing would typically form.

According to one aspect, there is provided a system for enhancing the efficiency of a propulsion rotor blade, the system comprising a propulsion rotor blade defining a pressure face and a suction face, wherein a vortex inducer is applied to the pressure face of the blade, The vortex inducer defines an aft face the aft face is located forward of a trailing edge of the blade, such that, in use the aft face separates flow to induce a primary vortex behind an apex of the aft face. The primary vortex induces a counterrotating secondary vortex through viscous coupling at the trailing edge of the blade. The secondary vortex rotates tangential to the trailing edge to accelerate suction face wake and to deflect the suction face wake and further deflect the suction face wake away from the trailing edge.

The secondary vortex accelerates the suction face wake from the blade thereby causing the normal shock wave to translate to the trailing edge where the normal shock wave is replaced by an isentropic expansion fan thus further increasing the velocity of the suction face wake.

The vortex inducer may define a tapered profile, with the height of the vortex inducer increasing progressively towards the aft face. The blade may define a blade chord and the vortex inducer defines a height of between 0.25% and 2% of the blade chord. A distance between the aft face and the trailing edge may be between 50% and 500% of a height defined by the vortex inducer. In one embodiment, the vortex inducer may define an apex with a height, and the distance between the trailing edge of the blade and the aft face of the vortex inducer is proportionate to the height of the apex. The vortex inducer may be attached to the pressure face along a span of the blade between 0.6 to 0.95 of the blade radius. Furthermore, the vortex inducer's height may vary in relation to the chord length at different radial positions. The vortex inducer may define an outer face that is at least one of linear and ogive in shape.

Preferably, the suction face airflow is subsonic, and the secondary vortex accelerates the suction face wake to supersonic speeds.

In an embodiment, the suction face wake energises the secondary vortex, which further energises the primary vortex through viscous coupling, enhancing the stability and performance of the wake flow structure.

The blade may be a propeller, a helicopter rotor, or a prop-rotor, allowing the system to be utilised in various aerial propulsion applications. Alternatively, the blade may be a fan blade, which makes the system particularly suitable for use in turbofan engines, enhancing thrust and reducing vibrations. In some embodiments, the blade may be a marine propeller.

In some configurations, the vortex inducer may attach to tape bonded to the pressure face. In embodiments, the vortex inducer comprises at least one of looped, knitted and woven material.

Preferably, the vortex inducer is moulded from mouldable material bonded to the pressure face, enhancing structural integrity and alignment with the blade surface. In a more specific embodiment, the mouldable material comprises a thermosetting resin, such as epoxy resin, which provides excellent bonding strength and durability. The thermosetting resin may be cured in a single curing process, resulting in a single bond line between the vortex inducer and the pressure face, thereby reducing potential points of failure and improving long-term reliability.

The system may further comprise a holder tool defining a recess configured for holding a mould for the vortex inducer, facilitating accurate placement and formation of the inducer on the blade surface. The holder tool may include blade edge locating tabs, allowing precise alignment with the blade's geometry during installation. Additionally, the system may include a compression tool configured to compress the holder tool against the pressure surface, ensuring a strong bond between the vortex inducer and the blade. The compression tool may comprise a compression head configured to pass behind the trailing edge of the blade on insertion from the suction face, extending around the rear of the blade to contact an outer face of the holder tool. The compression tool may further define a handle and a fulcrum protrusion on an inner edge of the handle, configured to press against the suction face by leverage applied from a proximal end of the handle, providing a reliable and controlled compression during installation.

The system may also include a jet engine comprising the blade, with the jet engine defining a bypass duct and an exit nozzle, wherein duct velocity between the bypass duct and the exit nozzle is subsonic. The exit nozzle may be a mixed flow nozzle or an unmixed flow nozzle, providing flexibility in managing the exhaust flow paths. The system may also include a thrust lever controlling the jet engine, with a restrictor configured to limit the operation of the thrust lever to maximum thrust, ensuring controlled operation within safe parameters. The restrictor may incorporate a user-selectable lever motion limiting gate, which can be opened by force if necessary, providing an emergency override capability. Additionally, the system may include an alert output device operably coupled to the lever motion limiting gate, configured to generate an alert when the gate is opened by force, thereby alerting operators to potential operational deviations.

According to another aspect, there is provided a method of enhancing the efficiency of a propulsion rotor blade, the method comprising applying a vortex inducer to a pressure face of the blade, wherein the vortex inducer defines an aft face located forward of a trailing edge of the blade. The method further includes inducing a primary vortex behind an apex of the aft face by the flow separation caused by the vortex inducer and inducing a counterrotating secondary vortex through viscous coupling with the primary vortex at the trailing edge of the blade. The method also comprises accelerating and deflecting the suction face wake by the secondary vortex and further deflecting the suction face wake away from the trailing edge to enhance blade performance.

These features, individually or in combination, provide improved aerodynamic efficiency, increased thrust, and reduced vibration, enhancing overall propulsion system performance.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows representative airfoil with leading edge, trailing edge, lower surface, and upper surface, charted with the percentage of chord and distance above or below the chord line.

FIG. 2 illustrates geometry of a vortex inducer, showing the vortex inducer applied to the pressure face of the blade section, with details of its height, aft face, and offset from the trailing edge.

FIG. 3 shows the vortex inducer on a blade, illustrating the bonded tab on the lower surface of the blade proximate to the trailing edge, along with the offset and extent of the tab span.

FIG. 4 shows standard velocity profile of a section, depicting Mach number for upper and lower flow conditions relative to the chord station for a subsonic free stream velocity.

FIG. 5 shows Mach numbers for modified blade section, showing continuous sonic flow over the upper suction face and conditions leading to the absence of a normal shockwave.

FIG. 6 provides a comparison of standard and modified Mach profiles, overlaying the velocity profiles to illustrate the effect of the Prandtl-Meyer Expansion Fan on upper and lower surfaces.

FIG. 7 shows Prandtl-Meyer Expansion Fan conditions resulting from a stable trailing edge vortex, detailing the interaction of primary and secondary vortices and the expansion fan effect.

FIG. 8 shows a holder tool, showing the design and features used to locate and hold a silicone mould insert in place for blade modification.

FIG. 9 shows a compression tool, illustrating its fabrication and the method for applying uniform compressive force to the blade modification area.

FIG. 10A shows the holder and compression tools, showing the tools in position relative to the blade.

FIG. 10B provides the compression tool detail from blade aspect, providing additional views of the tool design and function.

FIG. 11A shows a standard energy budget, representing the conventional energy distribution for an engine with unmodified blades.

FIG. 11B shows a modified engine energy budget, comparing the energy distribution for an engine operating with modified blades.

FIG. 12A illustrate duct types in a turbofan engine, showing convergent and divergent duct sections relevant to supersonic and subsonic flow conditions.

FIG. 12B compares divergent and convergent nozzles, illustrating the differences in velocity and pressure effects between subsonic and supersonic flow conditions.

FIGS. 13 and 14 shows a thrust lever controlling a turbofan engine, with a restrictor configured to limit the operation of the thrust lever to maximum thrust, ensuring controlled operation within safe parameters

### DETAILED DESCRIPTION

Propellers and rotors are generally efficient in acting on the relevant fluid medium, however they are essentially constrained by the need to achieve a differential in velocity to the fluid to achieve thrust, by any means a mass is accelerated to develop a force, which may be considered as a mass flow rate, \dot{m}, by a differential in velocity, δV, (delta V, acceleration over time). To gain greater thrust, either \dot{m} or δV must be increased over the reference condition. A constraint exists in fluid mechanics that mass flow choking can be expected to occur in many cases where the velocity is increased to an extent that a blockage occurs from a formation of a compression shock, a “normal shock”. It has long been known that at the choking mass flow rate which occurs at Mach 1, \dot{m} becomes maximum for a system. The formula to derive that is:

$$\dot{m} = ( \frac{A \cdot Pt}{\sqrt{{T}_{t}}} ) \cdot \sqrt{\frac{γ}{R}} \cdot M \cdot {( 1 + \frac{γ - 1}{2} \cdot {M}^{2} )}^{- \frac{γ + 1}{2 ( γ - 1 )}}$$

Where M is Mach, and therefore the maximum flow rate occurs where M=Mach 1 as follows:

$$\dot{m} = \frac{A \cdot Pt}{\sqrt{{T}_{t}}} \cdot \sqrt{\frac{γ}{R}} \cdot {( \frac{γ + 1}{2} )}^{- \frac{γ + 1}{2 ( γ - 1 )}}$$

This flow condition has been a limit of turbomachinery design, and a configuration that results in a local velocity that exceeds Mach 1 will generally fail to compute, or the software will alter the exit area, A, to lower the maximum Mach to 1.

The invention discloses three significant factors that appear to have been overlooked in the fluid mechanics of propulsion and provides methods to achieve the benefits of the underlying discoveries: Discovery 1—flow from a propulsion rotor consisting of blades can exceed Mach 1; Discovery 2—flow efficiency from a propulsion rotor consisting of blades can be increased where downwash “E” from the blades is increased over conventional design; Discovery 3—flow in a turbofan bypass duct can exceed Mach 1 without choking and Discovery 4—Wake noise with increased performance from the establishment of an expansion fan on the fan blade is reduced when comparing equal thrust cases.

### General Physics Required to Achieve the Discovery Outcomes.

An effective device to achieve the outcome described derives from the “Gurney Tab” “GT” however named, but with certain unique features. The GT has long been known to be able to increase coefficient of lift “C_{L}” on a section, however, it is also well established that the drag coefficient, “C_{D}”, is higher at low to moderate angles of attack, “a”. Because of this, the GT has remained largely a curiosity of aerodynamics, as an airfoil sections utility generally requires greatest

$$\frac{{C}_{L}}{{C}_{D}}$$

referred to as L/D ratio. The focus of almost half a century of research has been on 2-dimensional analysis of the GT, and has clearly determined that for 2-dimensional static conditions, the only occasion that L/D is improved with a GT is at a approaching stall angles, where the normal rise in C_{D} is mitigated.

The research that has concluded this is quite correct within the frame of reference that is applied, but it is not always strictly true. The increase in drag is observed as a wake velocity deficit, and is in part the result of greater downwash, “ε”, or turning of the wake behind the foil. For considering a blade in 2-dimensions, this is seen as a drag increase, but it also reflected in the lift increase in part.

The velocity of the wake from a blade is a vector and has axial as well as tangential components. Propulsive disks such as propellers, rotors and fans achieve a substantial amount of swirl in the wake from the disk, and this detracts from the axial velocity, which is the component from which thrust is achieved. The geometry of a propulsion rotor is such that the axis of the rotating shaft the blades are attached to at a pitch angle, β results in an inflow from the advance of the disk. The advance and the associated inflow velocity result in β angles to achieve a blade section α that provides positive lift being quite high compared to a case of a 2-dimensional analysis of an airfoil. What is not obvious is that the downwash angle on a propulsion rotor alters the flow coefficient, φ, where:

$$ϕ = \frac{{V}_{a 2}}{{U}_{2}} = \frac{m / ρ \cdot A}{U}$$

Where:
Vₐ₂ Absolute axial flow component
U₂ Blade tip speed
m mass
ρ density
A area
U velocity

It follows that the increase in downwash angle from a blade on a propulsion rotor results in an alignment of the wake vector towards the axial direction of the propulsion rotor. This is contrary to the expectations of a 2-dimensional analysis of a GT on an airfoil which has been the basis of half a century of research which has concluded that GT's are of limited benefit due primarily to their loss of efficiency on a blade at operating α. Contrary to 2-D section modelling of a tab, the turning of the wakes exit angle or downwash, ε, by a vortex inducer structure results in increased axial flow, which is considered in the 2-D case to be a wake momentum deficit, but in the wake of a propulsion rotor is not so, it is realigned from tangential to axial, and thus is an increase in thrust while also reducing the drag, overall increasing the lift/drag ratio of the disk. This altered flow vector occurs in all cases where a GT is applied to a blade, but the consequences can be amplified by higher velocity conditions.

Transonic conditions occur on propulsion rotor blades frequently in operation. While the tip velocity may be subsonic, the α of the blade section will naturally be operating at a positive lift angle, and as such the flow over the suction face of the blade will be accelerated, lowering pressure. This acceleration will result in the flow being accelerated above a local Mach 1 condition, where local Mach, “a₀” is:

$${a}_{0} = \sqrt{γ R {T}_{0}}$$

Airfoil exit velocity will be lower than the peak velocity on the suction face, as an adverse pressure gradient occurs towards the rear of the blade section, resulting in the local velocity of the flow slowing down on the blade. This will result in the sonic flow case slowing down to Mach 1, at which point a compression shock will form, which is non isentropic. This shock position is sensitive to any perturbations of the section α, and this then results in the center of pressure of the blade being unsteady. A pressure recovery behind the normal shock brings the suction on the blades suction face closer to ambient pressure, which lowers the C_{L}, while the shock itself and flow separation behind the shock increase C_{D}.

In the case of the invention applied to a blade section with a transonic flow condition, the acceleration of the flow at the trailing edge due to the secondary vortex rotation inducing a higher velocity of the wake at the trailing edge of the blade airfoil results in the mitigation of the adverse pressure gradient on the suction face of the blade. This is a feedback loop, where the shock position is dependent on the exit velocity, the secondary vortex increases the exit velocity of the upper wake, which intensifies the vortex through viscous interaction at the boundary of the vortex flow and the wake. This condition may result in the complete removal of the normal shock, where it has been relocated to the trailing edge, at which point Prandtl-Meyer expansion fan conditions exist.

The Prandtl-Meyer expansion fan is an isentropic condition, which is therefore of greater efficiency to the system than a case where a normal shock would conventionally be encountered. The expansion fan both results in, and is caused by an expansion angle existing, in a flow that is sonic. The expansion fan increases the wake exit velocity dependent on the achieved expansion angle given by Meyers 1908 doctoral dissertation as:

$$v ( {M}_{2} ) = v ( {M}_{1} ) + θ$$

and
θ=expansion angle
v(M₁)=velocity before the expansion fan
v(M₂)=velocity after the expansion fan

The discovery herein disclosed is that a Prandtl-Meyer expansion fan does not require a rigid geometry to be established as prior art has always applied, and that it can be achieved because of the application of a flow control modifier that is not located at the point of the expansion fan loci, it is a consequence of the flow deflection caused by a vortex structure. No prior art has described such a case occurring due to a vortex structure.

Prandtl-Meyer type expansion fans are characteristically formed by physical geometry, such as the supersonic wind tunnel duct, diamond wing structure. In the wake of both the under expanded and over expanded sonic flow nozzle will result in a series of expansion fans from either the edge of the nozzle or the lateral boundary conditions of the wake, or with shock interference. There is no vortex structure occurring in these known conditions of Prandtl-Meyer expansion fans being formed. Unique to this invention, the expansion fan results from the vortex structure of the GT on the pressure face of the blade. Thus, a device being otherwise disregarded as a method to achieve increased efficiency results in greater flow coefficient when applied to a propulsion rotor blade, due to alignment of the flow in the axial direction which is otherwise considered to be a loss of efficiency when considered in 2-dimensional analysis, or in 3 dimensional analysis not considering thrust outcome, and it importantly achieves a Prandtl Meyer expansion fan condition, while removing the normal shock, in otherwise transonic conditions, which results in greater suction on the upper surface, a greater exit velocity which is sonic, and which is turned further towards the axial, thrust beneficial direction, resulting in greater axial δV, being increased thrust.

For a propeller, helicopter rotor or prop-rotor case this is a resultant condition, where axial velocity in the wake is greater and is aligned closer to the thrust axis, and the tangential velocity for a given tip speed is reduced.

For the turbofan engine case, this is a part of the outcome due to the inherent issues of mass flow choking in a duct.

The turbo fan engine ingests mass at the inlet, and a part of the flow is then processed by the core of the engine by compression, burning and expansion to provide both a thrust from the jet exhaust and to provide torque to rotate the compressor and fan stages, with the fan providing thrust in the bypass duct. Where the duct of the engine limits an area of the flow path, mass flow choking will occur when local Mach=1, this being the point of maximum possible mass flow. Design has evolved to consider this to be an absolute speed limit within a duct, and that is not correct, it is possible to exceed the Mach number in a conventional condition, with the flow choked, it is just lower efficiency. It is also possible to bypass the condition of mass flow choking if a certain set of conditions occur.

The flow within a turbofan is a series of convergent, divergent ducts acting to process of the flow. The conventional condition is that the flows behind the intake are subsonic, to avoid mass flow choking. The addition of the GT to a fan blade can result in sonic exit conditions being possible from the fan, which also happen to have greater axial alignment than conventional blade designs. This sonic flow condition would reasonably be expected to be precluded by mass flow choking, if Mach 1 was a physical limit, but if not, the underlying design of the duct area changes which are designed to stop choking of mass flow now act in the opposite sense to the subsonic Bernoulli's theory, that is the flow going into the bypass convergent duct being sonic will not increase V, it will reduce V, and pressure will rise. The stator is a diffuser in effect, which is equivalent to a divergent duct, and if the deceleration of the flow after the fan to the face of the stator has remained sonic, it will exit the stator with higher exit V than the entry V, and commensurately a lower P. This flow then proceeds down the remaining duct to the nozzle whether mixed or unmixed, but it is notable that it is higher V than conventionally achieved. The higher nozzle V provides a greater δV of the fan exit case, which increases gross thrust achieved by the bypass. This is of interest, however, the fact that net thrust is the only force of interest with a body in motion, the higher exit velocity compared to entry means that the δV is greater at high speed, when the conventional design was constrained to a subsonic flow within the bypass duct and could only achieve a small measure of velocity increase at the final nozzle convergent-divergent condition.

The result of the higher velocity in the fan duct, which can be maintained at a sonic velocity is that net thrust is increased markedly at high vehicle true air speeds.

To the date of this specification, testing on turbo fans of 2.3, 2.8 and 6.1 bypass ratios, BPR indicate that the greater the BPR, the greater the gain in efficiency, and the faster the vehicle's true airspeed, TAS, the greater the effect.

### Materials

To achieve these outcomes is certainly challenging in material science, however, it is quite possible, and as the outcome of achieving any one of these three discoveries alters the efficiency of propulsion by extraordinary amounts, that the change can be implemented and demonstrated has been a primary target of the development of this technology. The material challenges are numerous and are dependent on the application, however, the main challenges are to achieve properties that: do not cause structural failure to the blade itself, that do not degrade in liquid droplet impact, have benign failure modes that do not damage the power plant or aircraft.

The solution on a propeller helicopter rotor-blade or prop-rotor blade involving elastomeric materials fails in practice, as both particulate impacts and particularly liquid droplet impacts result in accelerated fatigue of the elastomer bond and a rapid breakdown of the material, and loss of effectiveness, and with liberation of material.

Elastomeric materials for use as vortex generators was proposed in an earlier patent by Ireland and is not suitable for velocities above 90 m/sec as described in that patent claim. This patent additionally excluded conditions where the flow would be accelerated to above sonic, this being expected to be adverse to the outcome, contrary to the discoveries described herein.

The propeller, helicopter rotor and prop-rotor permit the establishment of the Prandtl-Meyer expansion fan effect by the application of a GT like structure using a woven or knitted material which in its simplest form can be described as consistent with the Velcro Loop part of the “hook and loop” fastening system originally developed by Velcro. The features of importance are a material that is not elastomeric, that is, does not rely on elastomeric compounds within the material to provide the desired properties. The natural flexibility of a knitted or woven filament is such that it is able to be compliant to a substrate that is subject to deformation in torsion and bending without altering the substrates inherent mechanical properties. In particular, the knitted or woven filaments of this material type break the surface tension of the droplet in high velocity impacts, and this avoids the catastrophic effects of high impact velocity with such droplets. In the case of particulate impact, the flexibility of the filaments permits the mitigation of the peak impact energy transfer to the filament and avoids erosion occurring. Aerodynamically, a knitted or woven material will alter flow sufficiently to achieve the same outcome as a solid or elastomeric materials will achieve.

The thickness of the material with adhesive included can be altered by addition of a substrate below the loop like material, which may be preferably a wedge shape extrusion of a light weight material, or may be incorporated in the material itself. Mass on a propeller, rotor or prop-rotor is less significant than a turbofan blade due to lower radial acceleration, however, it is still a factor in the reliability of adhesive bonding, and the mass should be kept as light as possible. A wedge shape is desirable for a minimum mass for a given trailing edge vortex inducer height but is not necessary for the accomplishment of an increase in efficiency. Where height is increased by adding a substrate such as a VHB tape, it is desirable to add a protective bead to protect the edge of the tape from impact and chiseling failure of the bond line. Sealants such as 3M™'s DP-3950 edge sealer and similar products may be applied.

Ice-phobic materials and treatments may be applied to the loop material, however, the vortex inducer results in a pressure increase on the forward face of the material, which results in a localised heating of the surface of the front edge of the vortex inducer and mitigates to an extent ice accretion. The atomising of liquid and the shearing of crystallised ice will result in a release of heat, which will lower the temperature of the water or ice crystals, however this occurs on a surface that is compliant and deformable by nature, and which impedes adherence of ice to the device.

For embodiment on a turbofan, elastomeric materials fail under tension, and the bonding surface energy is inadequate resulting in adhesion failure.

A subset of epoxies have been determined to be suitable to forming a bonded component in a preferentially single curing process. A single cure resulting in both the formation of the device, and the bond of the device to the fan blade surface results in a single bond line. Alternatively, a two-step mould and bonding process can be conducted, however this increases the risk of bond failure.

It is critical that the bonded component in all cases follows the shape of the blade surface which is a complex 3-D surface. To achieve this, a model of the blade region that is to be modified is 3-D scanned or otherwise determined, and a mean shape of the surface is developed. From this surface, a generally conforming tool face is produced, to which a silicone mould which incorporates the shape of the modification is developed. The mould has shoulders that are compressed along with the body of the mould by the tool to provide a force towards the blade surface to achieve a contact of the adhesive across the area of the adhesion of the part to the blade. While it may seem appropriate to produce a monolithic design of a blade which incorporates the device proximate to the trailing edge of the blade, the mechanical properties of the blade necessary to survive in high radial load conditions precludes changing the profile of the blade abruptly at part span without resulting in causing a stress concentration at the location of the change in material thickness, this section of the blade otherwise being generally of a low thickness between the upper and lower surfaces at the chord station of the blade. Existing exotic composite materials will be challenged with stress concentration with a monolithic design incorporating a localised profile change to develop the flow characteristics, but future materials incorporating higher performance matrix materials may remove this impediment. In such future cases, where some material such as carbon nanotubes are applied to survive stress concentrations, the remaining problem with monolithic structure will be surface damage on the pressure face, from particulate impact. Where such impact occurs in use, material loss will occur, and this can result in exposure of the matrix materials of the composites. Considering this problem, an additive device that achieves the Prandtl-Meyer condition is desirable, permitting repair without affecting the substrate material, and not altering the structural response of the blade from loads imparted in operation.

The tooling that is shown in figures has achieved the modification of 30 blades with a permanent epoxy material device in one hour with a team of 2 engineers. This includes preparation of the blade surface following standard practice, adding an adhesive promoter such as 3M™'s AC-130-2 surface pre-treatment sol-gel. The use of an adhesive promoter has been desirable for high radial acceleration applications, but may not be necessary with larger, lower RPM fan blades where radial loads are less.

Repair of the device on the blade is possible, using the same mould and tooling, but applying an amount of epoxy equivalent to the amount that has been lost, determined by survey. It is possible to alternatively remove a known amount of the device material with a scraper that has an offset to result in retaining a known amount of volume of material on the blade, and then applying a similar volume of material in the mould to achieve the final shape.

### Vibration

Shock structures are generally sensitive to angle of attack changes, and on the standard section, the shock is perturbed by any variation in angle of attack, resulting in significant changes in lift, drag and pitching moments. These variations result in vibration on the section, which is imparted to the blade structure, hub attachment, and through to the source of shaft torque provided to the propulsion rotor. Ultimately, the vibration that occurs is exacerbated by any condition that results in a periodic change of angle of attack, and this occurs due to any non-axially aligned inflow to the actuating disk. Vibration is a significant factor in low frequency fatigue of any system components.

Due to the impact of vibration, and the cyclic change in loads on the disk that will normally occur, the implementation of a modifier to a section on any blade is potentially a critical change to the structure and it's potential to fail from low frequency fatigue. Prior disclosed art by the inventor considered the application of elastomeric materials, however, testing showed that the material failed in abrasive conditions, in rain from the effect of liquid droplet impingement fatiguing the elastomer bonds and resulting in failure of the material, and a failure to achieve a suitable adherence to the substrate with the radial acceleration and cleaving loads applied to the material of the tab.

### Operational Considerations

The aerodynamic effect of the modification to a fan blade result in an increase in thrust from the bypass flow, which results in a potentially paradoxical impact to overall thrust achieved from the engine, where it is necessary to contain the fan thrust load within the thrust rating of the thrust bearing, fan frame, pylon, and wing. This occurs at a lower RPM, and consequently, while the fan thrust is matched, a deficit of core thrust component will occur, resulting in an overall derating of the engine, unless margin exists in the design of the fan load path to achieve an increased thrust from the fan to match the total thrust from both the fan and core to the original condition. This paradox is most notable at low bypass ratios, and with design that results in a large increase in thrust at sea level, below the critical temperature for the engine thrust output. This factor is primarily a static thrust condition issue, and at the conventional thrust set speed of 60 to 90 KCAS, the reduction in net thrust for bypass ratios of above 2.8 will mitigate this issue, particularly where care is taken in the design of the modification. It is important however to alert the operator to avoid operating the engine in static conditions at RPM that will exceed the thrust rating of the fan bearing and support structure.

For Boeing aircraft, it is possible to provide simplified procedures to ensure that the achieved total thrust does not exceed the sea level thrust below the critical temperature, by applying a lower thrust rating target N1, and adding an assumed temperature method as well, which is consistent with the FAA AC25.13 Reduced and Derated Takeoff Thrust (Power) Procedures. The invention disclosed can achieve considerable increase in thrust at low density altitudes, which impacts controllability of multi engine aircraft in the event of an engine failure.

For a percentage increase in thrust above the certified thrust target and associated reference speeds, an increase in minimum control speed of ½ the percentage increase in thrust percentage will occur. Due to this, it is a critical requirement for the certification of an aircraft with this invention applied to provide guidance to the operator on the impact and mitigation of lateral-direction control impacted by any occasion that the crew may elect to increase thrust above the rated thrust level applied in the certification of the modification. Two occasions may be encountered where a crew may deliberately exceed the rated thrust of an engine as certified, these being (i) on a windshear event or a failure of performance of the aircraft; (ii) in a ground proximity/terrain avoidance manoeuver. In these conditions crew training conventionally advises the flight crew to use any and all thrust that may be available up to the physical limit of the engine control in order to avoid the immediate threat. The modification provides far higher thrust in this case which then impacts the minimum control speed, but will result in significantly higher pitch-thrust couples for aircraft with underwing pylon mounted engines. In such cases, the crew must be aware that the increased nose up moment of the engines will require appropriate and rapid counter control inputs to ensure that the pitch attitude does not become extremely nose up. It is a desirable practice to ensure that the crew have guidance material on this condition.

While density reduction with altitude will avoid excessive thrust loads occurring at moderate altitudes and higher temperatures, a go-around condition requires advice to the flight crew to conduct a single selection of the TOGA levers on Boeing aircraft, to maintain pitch authority for the aircraft within usual levels that the crew encounter on a standard aircraft. Selecting the TOGA levers twice will command an RPM limit that is the rated go around thrust target for the powerplant, which will be excessive in all but an emergency condition. To avoid this occurring while it is desirable to have an amended target value for the auto throttle, it is also possible on Boeing aircraft to provide a physical adjustable stop to the thrust levers, which can provide a restriction to the lever advancement and alert the crew to the potential to have excessive thrust from the engines.

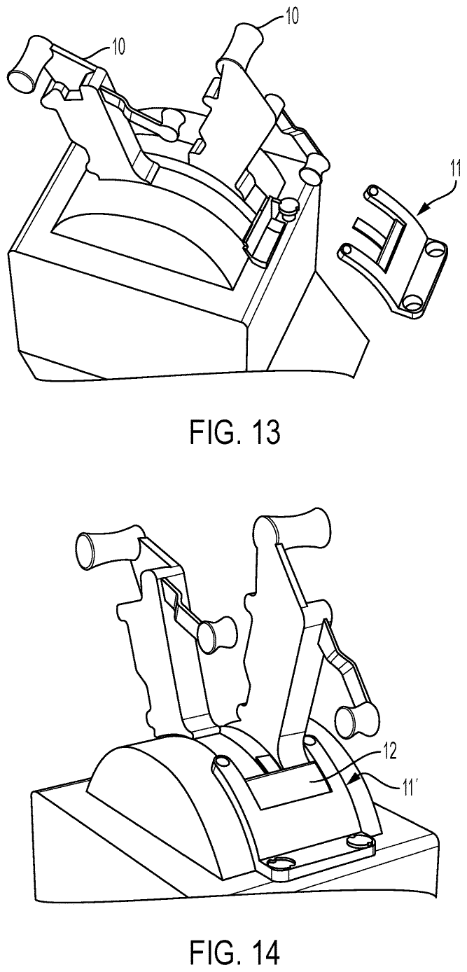

FIGS. 13 and 14 shows a thrust lever (10) controlling a turbofan engine, with a restrictor (11) configured to limit the operation of the thrust lever (10) to maximum thrust, ensuring controlled operation within safe parameters. The restrictor (11) may incorporate a user-selectable lever motion limiting gate (12), which can be opened by force if necessary, providing an emergency override capability. Additionally, the system may include an alert output device operably coupled to the lever motion limiting gate (12), configured to generate an alert when the gate (12) is opened by force, thereby alerting operators to potential operational deviations. The restrictor (11) may be equipped with contacts that trigger an alert (26), either aural or visual, when the lever (10) has been moved beyond the preset limit. This feature ensures that the operator is notified of the levers' extended motion beyond the limiter, enhancing operational safety.

### Engine Pressure Ratio, EPR Controlled Engines

Rolls Royce (RR), Pratt & Whitney (PW), and International Aero Engines (IAE) employ EPR for control of the commanded thrust of their engines. EPR is determined as the value of core exhaust pressure (p5 or p50)/engine inlet pressure (p2 or p20). Conventionally, as RPM increases, EPR will rise, as p5 rises slightly with RPM and p2 reduces with RPM. With the modification to the fan, a lower p2 for a given RPM will be mitigated by a greater mass flow being ingested, minimising the change in p2 but increasing m2 due to the increased axial velocity vector from the fan blade compared to the standard case at the same RPM. As mass flow to the core of the engine, m2.1 is not increased, there is no increase in fuel consumption for the given RPM of the core, and as drag of the fan blade is reduced, there is a slight reduction in fuel flow and N2 for a specific N1 case.

Testing is required to determine if the existing EPR targets will maintain loads within the desired targets.

### N1 Controlled Engines

Where N1 is the target for thrust setting, a new N1 target must be provided to avoid excessive thrust load on the fan thrust bearing and the fan frame. In general the new N1 target will be 6-10% lower than the original design to achieve a set thrust level. It is generally necessary to provide new N1 targets for the correct operation of the engine within the design thrust.

### Acoustic Signature

For a given thrust level, RPM is lower, and this will result in a lower frequency of fan blade/stator interaction. Total sound power level for the forward and lateral aspects of the engine are reduced as is normally the case with operations at lower RPM of any turbomachinery. Rear aspect acoustic sound power levels are lower than normal for high thrust settings but remain the same as normal for intermediate thrust settings. Overall, a reduction in fly over, sideline and approach noise levels is achieved, and may be sufficient in collective change to raise the certified noise category to the next higher standard.

Internal cabin noise is notably lower for equal thrust levels, following the RPM used to meet the required thrust for operation.

### Method for Modifying a Fan Blade In-Situ-Fan Blade Application

A novel means of applying a modification to a fan blade is disclosed. The standard blade is required to be cleaned which may be done by isopropyl alcohol or by methylethylketone MEK where available. In a confined space of an intake to the fan face, it is prudent to comply with standard occupational health requirements for confined spaces, and to use a mask that protects from volatile solvents. On titanium or steel blade surfaces, or with carbon fibre blades, abrasive materials should not be used on the surface.

Tool design is dependent on the actual blades compound shape but is generally described herein. The outer span of the blades pressure face, including the shape of the trailing edge should be scanned or otherwise determined. A holder tool 10 is produced to give a face area 20 to the blade pressure face towards the rear of the blade 30 that is conformal to the surface of the blade, and which has tabs 40 that extend past the face area of the tool, sufficiently to provide a register of the face area at a repeatable chordwise position with respect to the trailing edge 50 of the fan blade. The face area of the tool has a recessed area that becomes a receptacle area for a silicone moulded insert 60 which may preferentially have a slight dovetail to the extension of the insert that is pressed into the face area of the tool. The dovetail of the tool face area to hold the silicone insert in place is desirable but a close tolerance fit of the insert to the receptacle of the tool face area is acceptable as an alternative geometry. A further alternative can be applied by using a double-sided tape adhesive or an adhesive that will provide a bond of the silicone insert to the receptacle of the face area of the tool. The silicone or other mouldable, low surface energy material insert is separately formed in a mould to achieve the shape of the additive device that is being applied 70. Where the installation is alternatively conducted with an insert that is not formed from silicone or other low energy surface material, a release agent will be required to be used in the insert cavity 70 that will form the final additive shape. The tool has a face width 80 sufficient to provide the receptacle with the span of the blade required for the additive device. When the tool is in place on the blade pressure face, and with the rearmost tabs in contact with the trailing edge of the fan blade, the edge of the tool will locate against the inner cowling surface to provide a repeatable location register for the tool, and thus provide a repeatable location spanwise of the insert location in the receptable, and therefore of the additive component to the blade outer, rear pressure face position on the blade 90. The use of a silicone or other compressible material for the insert mould is desirable, as it will readily conform to the blades compound, 3-dimensional shape, and permit a compression of the mould to the surface of the blade. To achieve compression of the mould to the blade surface, a further tool, the compression tool, 100 is produced to fit around the suction side of the blade opposite from the holder tool, and to hook around the trailing edge of the blade, and to contact the outer face of the holder tool aligned approximately with the center of the width of the insert, and contacting along the span of the insert. The tool may preferentially include a raised section of the tool handle that contacts the suction face of the fan blade and acts as a fulcrum that then permits the tools outer handle to be brought towards the handle of the holder tool, which with the fulcrum will result in the hook end being drawn towards the outer face of the holder tool, and on contact, producing a compression of the holder tool at the area of the insert, causing a compression of the insert towards the pressure face of the fan blade.

Preferentially, a clip can be fabricated to apply a clamping force to the compression tool handle proximate to the leading edge of the fan blade. A U or C shaped clip with a series of grooves on the arms of the shape facing the leading edge of the blade allow the clip to be locked onto the blade, while applying a compressive force to the forward most part of the compression tool blade, forward of the fulcrum, and where there is slight flex in the compression tools handle, this flex will achieve a locking force on the clip. Once clipped in place, the holder tool, insert, and compression tool are locked in place applying a compression force to the area of the insert, giving a reliable bond of the material to the blade surface.

Prior to conducting the addition of the material to the blade, an adhesion promoter such as 3M™ AC130-2 Sol-Gel Adhesion promoter can be applied sparingly in the pressure face outer aft span region. This is not necessary for larger, low RPM fan blades, but is likely necessary for small diameter, high RPM fan systems. This step is preferable but not necessarily required.

A mixture of short pot life epoxy adhesive or similar adhesive is mixed, which may include modifiers such as cotton flox, or carbon fibre filaments, or single wall carbon nanotubes may be applied to the mix. Additives are optional, and will generally increase the tensile strength of the epoxy mix under shear loads, and increase the surface hardness. It is desirable to ensure that the additives do not result in excessive hardness of the final cured material, it is highly desirable to have a mix that will survive limit operating conditions, but on a fracture of the surface will become frangible and avoid damage to the inner lining of the inner shroud of the nacelle duct, avoiding damage to the duct lining or the stators behind the fan within the bypass duct. The exact mix is dependent on the engine application, however commercial rapid cure “steel epoxies” have performed adequately in testing, and are enhanced with addition of flox. Addition of SIO2 will also increase the surface hardness of the epoxy, and shorten the time to set of the mixture. The epoxy applied should preferably have an operational temperature range of −50 C to +150 C, however −40 C to 300 C has also been used effectively. An excessive additive amount of flox and SI02 will cause many 2-part epoxies to become exothermic and should be avoided.

When the blades have been cleaned and tools are prepared, the insert in the holder tool can be carefully filled with the fully mixed epoxy mix, avoiding excessive material being applied. It is critical to ensure the inserts mould cavity is filled without leaving voids in the mixture. Any voids in the mixture will result in a failure of the material in operation, and if on the base of the material, will result in release of part or all of the device under radial acceleration, air loads and impact from particulates.

In testing, it has been desirable to have multiple full tool sets to achieve a rapid modification of the blades. For large diameter blades, the number of blades that can be worked on with the tools from a single epoxy mixture will be less than for smaller devices on smaller diameter blades. As a approximate guide, 8-10 tool sets are suitable for a 1-meter diameter fan, and 4-5 tool sets are suitable for very large fan diameters. It is desirable to have additional inserts on hand, when the tool clip and compression tool are released from the holder tool, it is possible for the insert to adhere to the moulded part, and this should be left in place until the adhesive has cured to ensure that the shape and bond is not affected by efforts to release the insert.

### Propellers, Helicopter Rotors and Prop-Rotors

A condition of a Prandtl-Meyer expansion fan is achieved by the addition of a vortex inducer proximate to the trailing edge of the blade, with an offset forward of the trailing edge that is in the range of 0.25-5 times the height of the tab. The vortex inducer is applied as a part span addition to the blade. Generally the span will be from 0.6 radius to 0.95 radius of the blade however this is dependent on the blades characteristics and the addition may extend outside of these areas to achieve optimum performance gain. The variables that may affect the span wise extent are the blade twist, blade section, and velocity, and the blade tip geometry as a practical factor. The vortex inducer material preferentially is a woven or knitted filament bound to a substrate that permits adhesion to the blade surface. Materials such as Velcro “loop” have indicative properties that meet the operational requirement, providing for damage avoidance in liquid droplet and particulate impact. It is desirable that the filaments are ice-phobic in nature, however the vortex inducer results in pressure increase in the forward face of the device, and this results in an increase in temperature mitigating ice accretion in the standard range of icing encounters.

Installation of the vortex inducer should be done with a controlled offset of the trailing edge of the vortex inducer from the blades trailing edge, and from a defined point on the blade span to minimise mass balance induced vibration.

### Turbo-Fan Engines

Embodiment of the invention on the fan engine requires the use of a material that has a high strength bond to the surface of the blade. This material encounters extremely high radial accelerations. Elastomeric materials have been found to be unreliable to bond in place with a failure of the material as well as the bond occurring. Epoxies are suitable for use as a vortex inducer material, and in the preferred embodiment an epoxy mixture is fixed to the blade in an accurately registered location on the blade. The vortex inducer is located at part span outboard, altering the outer fan pressure ratio region only. Where a blade may have mid span shrouds, the application will generally be outboard of the shroud fins, however addition of a vortex inducer inboard of the shroud fin may also be accomplished, but must remain clear of the flow field to the core flow being the inner fan pressure region of the blade. Epoxies with additives may be employed dependent on the engine design and operating condition, however generally the material should be a fast setting epoxy, and exhibit high bond shear strength as well as high and low temperature limits. 5 minute epoxy with steel additives (steel epoxy) has been found to function well, and can be modified further with filaments such as cotton flox, single wall carbon nanotubes, and with silicon dioxide. Operating temperature ranges of the epoxy should tolerate temperatures well above 100 C however, epoxy rated at 300 C has been found to be effective but is not a limit case. The lower temperature range ideally should be tolerant to −40 C minimum, however this is not considered a limit condition.

Addition of the vortex inducer is preferentially achieved by a single bonding process where the vortex inducer is moulded in the same step as the bonding to the surface of the blade. A single process step minimises the number of bond lines that result, with a single material to blade bond being achieved.

Bonding of the vortex inducer may be alternatively conducted after prior forming of the vortex inducer and then applying an adhesive interlayer between the formed vortex inducer and the blade surface, this however results in two bond lines being used, and increases the risk of interstitial bond failure and loss of part or all of the tab.

Performance of the invention is moderately sensitive to the vortex inducer profile, however, due to high radial loads, a balance exists with mass and bonding surface area, which favours a wedge or triangular shape, with the apex of the shape at the rear. Limitations of accurate bond line pressure results in a preferential geometry that has a thin lower profile, with a wedge incorporated at a part chord of the base rearwards, 60, which gives a relatively large base area for bonding, and a minimum mass for the height of the apex and rear face of the device.

In moulding this device, a final shape is selected such as FIG. 7, 60, and this is then machined or formed by additive print process as a subtraction from a block to achieve a form for the mould and is formed to an upper plate for the mould. A lower mould is shaped which provides the shape to be formed to insert into the mould holder tool insert cavity 110 with an addition of the shoulder area around the reverse shape to provide a full contact of the final former to the blade surface. This shoulder area on the final preferentially silicone female mould when the holder tool with the mould in place in the cavity, is compressed by the pressure applied by the compression tool head 530 when the compression tool is hooked around the suction face of the blade, and contacts the outer head region of the holder tool, and where light pressure is applied to the handle 500 of the compression tool. A clip can be latched to the handle 500 to maintain a constant force on the silicone mould, and the epoxy mix that is inserted into the reverse mould former shape of the device.

### Propeller Prop-Rotor and Rotor Application

Installation on these types of devices involve a different technique, tooling and materials for the preferred embodiment of the invention. Span of these devices are generally greater than the turbo fan case described above. Airworthiness certification requires repeatable design, and that requires the location to be readily repeatable. Additionally, lower radial loads permit the installation of a partially or fully preformed mechanism as shear failures of bonds are less problematic. The installation is achieved with repeatability by using a tool to set an offset of the modification from a known location on the subject blade. A tip tool is described for conditions where the blade span is equal for all blades. For cases where there is variation in the length of the blade, a reference point on the blade, normally at 70% span can be used for the alignment. For the tip, as the shape of the blade tip may change in service from damage, blending and the process of surface removal at overhauls to remove fatigue damage to the material, it is necessary to have an adjustable offset tool to set the span wise position. The tool locates the tip and the front and rear edges of the blade, and provides an offset for the applicator. For a loop material tape, a guide tool is located at the spanwise reference point set by the offset tool and feeds the material onto a prepared adhesive bed on the blade pressure face which is itself the width of the tape that is being applied. The tape is preferentially pre-cut to the length of the final modification on the blade, or may be trimmed after installation, being careful to not scratch or score the blade surface however any damage to the surface in trimming is a significant risk to developing fatigue cracking and is not desirable.

The guide tool ideally provides a light compressive force to the material to promote good bonding. To achieve a compressive force, the tool has a vortex inducer that extends to the suction face of the blade, and a surface on the guide that contacts the upper surface of the applied material to compress it down towards the adhesive bed on the blade pressure face. The material has a desirable offset for the rear face of the material from the trailing edge, that is generally around 0.5 to 2 times the height of the rear face of the material from the surface of the blade. Generally, it is necessary to avoid the material base being aligned with the rear edge of the blade, or extending past the rear edge of the blade, as this will result in an area of the material that is not bonded to the blade. (It should be noted that generally all blades have a slight radius to their trailing edges to both faces of the blade and this will result in localized poor bonding if the material overhangs the radiused region of the trailing edge).

Where the designer of the modification determines that a higher trailing edge is desirable, for propellers, rotors and prop-rotors a transverse ramp can be added proximate to the trailing edge of the blade in the spanwise location that is desired to be modified. This ramp or wedge section can be preformed of a preferably low density polymer with high surface energy for adhesion, and then located with a tool to achieve the same general condition that the loop material tool achieves, that being the spanwise location of the ramp, with a repeatable offset from the trailing edge of the blade, and applied to an adhesive bed on the pressure face of the blade proximate to the trailing edge, over which the ramp will be bonded. Once the ramp is held in place, the upper material can be applied to an additional bed of adhesive on the upper surface of the ramp. High performance pressure sensitive adhesives (PSA's) and thin very high bond strength tapes (VHB's) can be used instead of methyl methacrylate's (MMA's) or flexible epoxies, either one or 2-part dependent on the design of the propeller and it's operating environmental conditions, which will determine the desired adhesive to be applied. Cyanoacrylate's can be used as well, however, the rapid tack and bond of these adhesives can result in location problems, adhesives with a short but non instant bonding generally give best installations. The ramp may be pre-formed out of a flexible material and held in a tool that can provide the full span or segments of the total span, and provide for a segmented installation.

For marine propellers, a segmented preformed material provides a simple means of installation in a similar manner to the aircraft propeller. Marine propellers do not directly benefit from a loop material overlay of the ramp section of the device, but this can also be applied if desired. Marine materials preferentially should incorporate a low surface energy on the upper face, however, as the material is not abradable, it may be tolerable to include a low level of metal into the mixture, this will then require care in removal or refurbishment or repair to avoid liberation of metals into the environment during maintenance.

### Unducted Fans UDF and Fans

UDF applications and fans driven by other than turbine power plants may employ either a loop type material for the device, in the same manner as a propeller, or an epoxy device similar to the turbofan.

### Transonic or Sonic Wings

Where the aircraft has a pitch control system that is not dependent on the flaps on the main wing, it is possible to remove the normal shock on the wing section forward of the flap directly from a device applied in a similar manner as the propeller, or turbofan type devices. The use of epoxy materials will generally be in sections to ensure the modulus of elasticity does not become a adhesive or structural problem. It is necessary to ensure that the structural deformation response to applied loads is not significantly altered by the device.

The effect of a device on a flap provides a direct reduction in drag from the removal of the n normal shock, however indirectly, this results in mitigation of the shock over the outer region of the wing as well, as the flap section will have greater C_{L}, and this results in a lower pitch angle being required for a given total lift, and therefore the outboard sections of the wing will achieve lower a, and any normal shock will be mitigated fully or in part. At low speeds, the device reduces drag and improves lift, however at speeds that require low a, but do not achieve transonic flow, a reduction in L/D will occur.

### Repair in Place

The tooling that is disclosed herein provides means to achieve an accurate chordwise and spanwise position with a compressive force towards the blade. For turbofan blades, damaged modifications on the blade can be refurbished with a slight variant of the tooling disclosed herein. A plastic scraper blade mounted on a tool where the blade has a notch to the blade across the blade span will permit accurate shaving of the bonded material spanwise along the blade, without risking damage to the blade surface from scratching.

This method of removing material will leave a base area of the modification remaining that acts as a peg for the original mould insert to be located over with an accurate volume of material in the mould insert, achieving a clean surface for the bond of the replacement material.

For complete removal of the material, an additional blade is applied to this tool, which removes the majority of the material from the surface but leaving a small residual amount of bonded material attached to the blade, that can be removed by applying solvents such as MEK and similar epoxy removal materials. Critical care needs to be taken on any carbon fibre blades, where the final removal of the epoxy is better served by being polished off the surface to ensure that the original gelcoat of the blade is not compromised.

### Airfoil

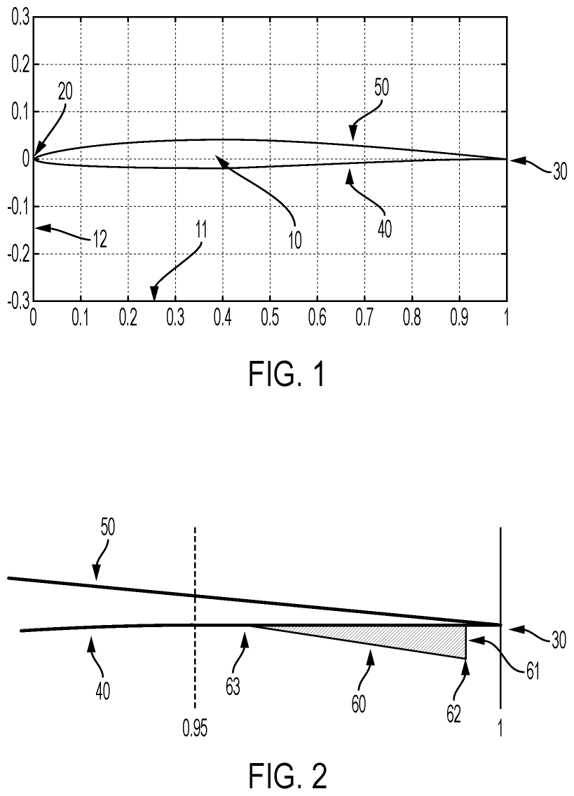

FIG. 1 shows a representative airfoil is shown 10 with leading edge 20 and trailing edge 30 lower surface 40 and upper surface 50 charted with percentage of chord 11 and percentage of chord as a distance above or below the chord line 12.

FIG. 2 shows vortex inducer 60 is applied to the pressure face 40 of the blade section, and has a height from the surface 40 proximate to the trailing edge, 30 resulting in an aft face of the tab, 61 from the surface 40 to the apex of the vortex inducer 62. The face of the vortex inducer 60 may be linear, ogive, or formed by compound shapes, such as a base area and a raised area. The height of the vortex inducer is preferentially between 0.25% of blade chord, to 2%, however in extreme cases may be greater. The distance of the aft face 61 of the vortex inducer 60 forward of the trailing edge of the blade is preferentially between 50% of the height to 500% of the height, and is dependent on the design of the blade, density and viscosity of the medium the blade is operating in, and the local velocity.

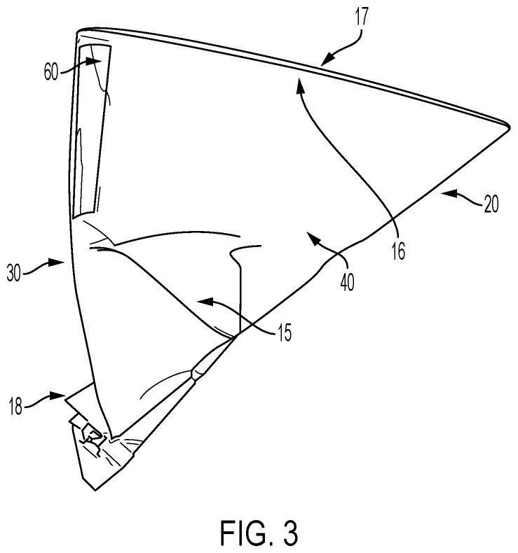

FIG. 3 shows the vortex inducer 60 being bonded to the lower surface 40 of a blade 10 proximate to the trailing edge 30. An offset is provided from the outer most extent of the vortex inducer 60 from the span of the blade 16. The extent of the vortex inducer 60 span inboard is dependent on the design of the blade but is generally around 20-25% of the radius of the blade. In this example, a mid-span shroud is shown 15 and it is necessary for the vortex inducer inboard radius extent to be outboard of such artefacts to avoid damage from the strong vortex shed from the intersection of the shroud protuberance and the face of the blade 40. The aft face of the vortex inducer 60 is forward of the trailing edge 30 as noted in FIG. 3. The height 61 of the vortex inducer apex 62 is a function of the chord length of the blade at the radius of the tab, between leading edge 20 and trailing edge 30. It is possible to alter the spanwise height of the vortex inducer however it is not necessary for a significant effect to be achieved. The offset between the outer edge of the blade 16 and the outer radius of the vortex inducer 60 may be varied, however a margin should be generally maintained to ensure bonding reliability. A tip vortex is developed from the high pressure face 40 of a blade, proximate to the outer span of the blade 16 and will traverse the end crossing the suction face outer span 17 of the blade to develop on the suction face of the blade 30.

### Velocity Profiles for a Section

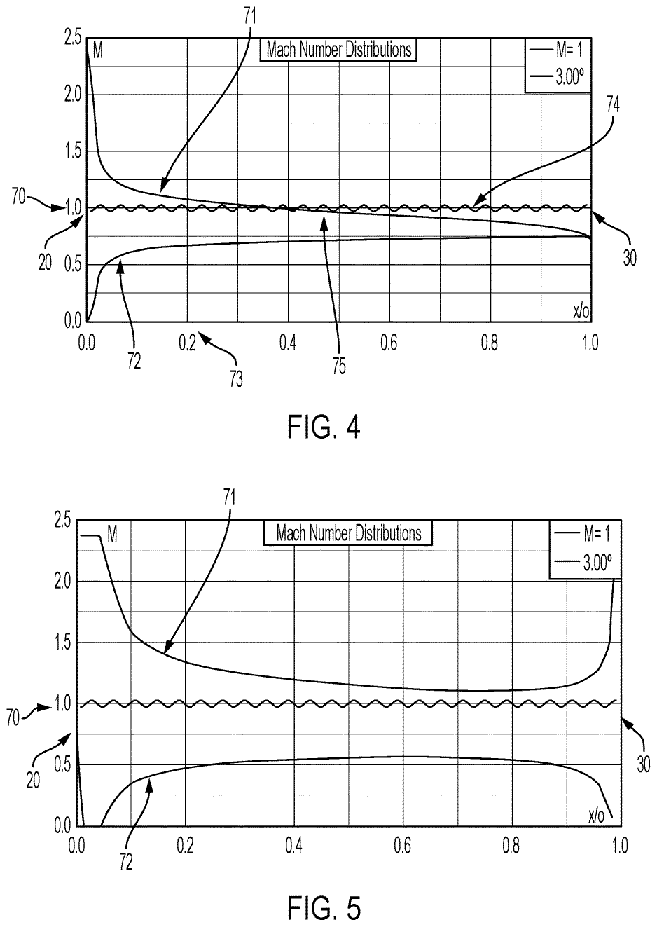

FIG. 4 shows representative plot of Mach number of a section for upper and lower flow conditions is shown relative to the chord station for a subsonic free stream velocity, and with a 3-degree angle of attack for a section representative of generic high-speed blades.

Mach number is presented on the Y-axis, from Mach=0 to 3.0. 70. The upper (suction) face 50 has accelerated flow above freestream velocity, V₀, and the Mach number Mᵤₚₚₑᵣ is shown 71 to be sonic in the forward chord of the section 73. Pressure face 40 flow Mach number is shown by the profile 72 for Mower. The region of Mach 1.0 on the section is show 74, and this indicates that the upper section flow slows down from being accelerated to sonic conditions mid chord 75 and is then subsonic decelerating to a very low velocity at the trailing edge 30. The lower, pressure face is shown to have lower than freestream velocity for the extent of the section.

FIG. 5 shows, for the same blade section as FIG. 3, and for the same angle of attach, a, and same freestream velocity V₀, and RPM, (or radial velocity for a blade W) the upper suction face 50 Mach number is shown 71 and it is sonic from proximate to the leading edge of the blade 20 to the trailing edge 30 and in fact it accelerates again proximate to the trailing edge of the section. The lower, pressure face 40 Mach number is lower than standard, providing higher pressure than standard across the extent of the chord. The Mach number of the suction face 50 remains continuously sonic, (above the Mach 1.0 velocity 70 and therefore there is no compression shock wave formed, and thus there is no ‘Normal Shockwave” formed on the upper surface.

This representation approximates the condition that occurs due to the vortex inducer causing a “Prandtl-Meyer Expansion Fan” to occur at the trailing edge.

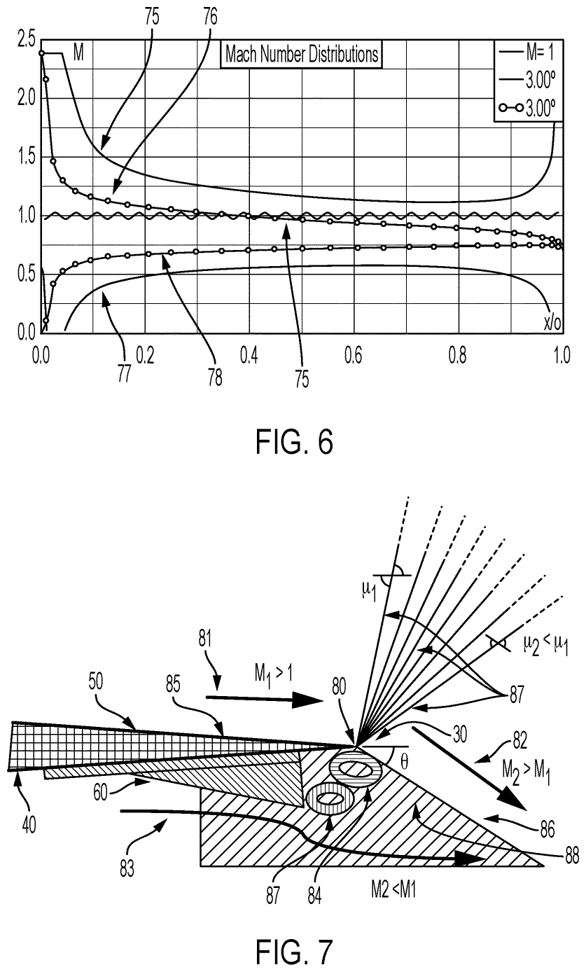

FIG. 6 overlays of the velocity profiles of the standard and modified case clearly show the effect of the Prandtl-Meyer Expansion Fan shows the upper velocity of the modification case 75 compared with the standard upper velocity 76 and the lower surface modified case 77 compared with the lower surface of the standard case 78. It is readily notable that (i) the modified case cannot have a normal shockwave, (ii) the suction on the upper surface modified is greater than standard, (iii) the pressure on the lower surface is higher on the modified case, and that the exit velocity from the section is far higher, being supersonic compared to low subsonic.

Novel Manner to Achieve a Prandtl-Meyer Expansion Fan on a Wing, Blade, Propeller, Rotor or Prop-Rotor without an Expanding Duct Structure

FIG. 7 shows a novel effect to velocity profile of a section with a resulting in sonic flow, and the TE vortex inducer resulting in a Prandtl-Meyer Expansion Fan (P-MEF) condition.

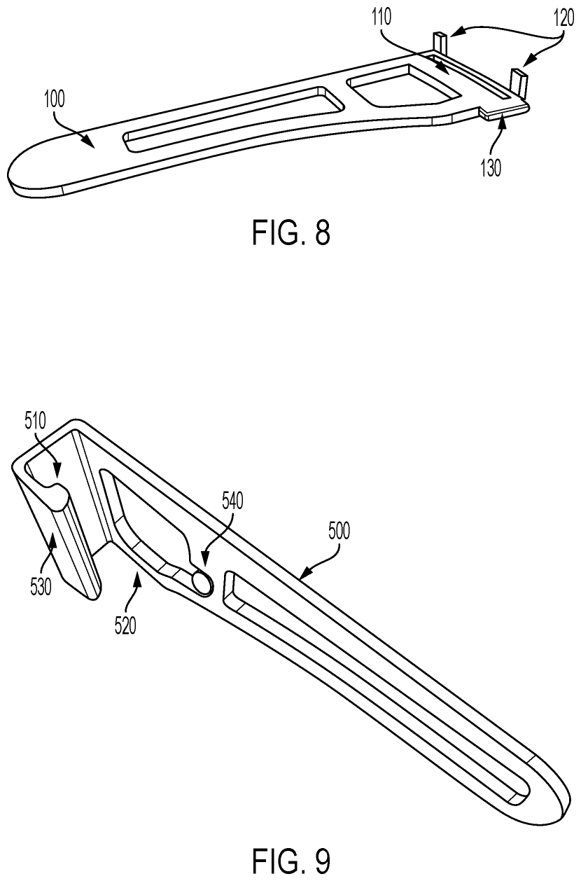

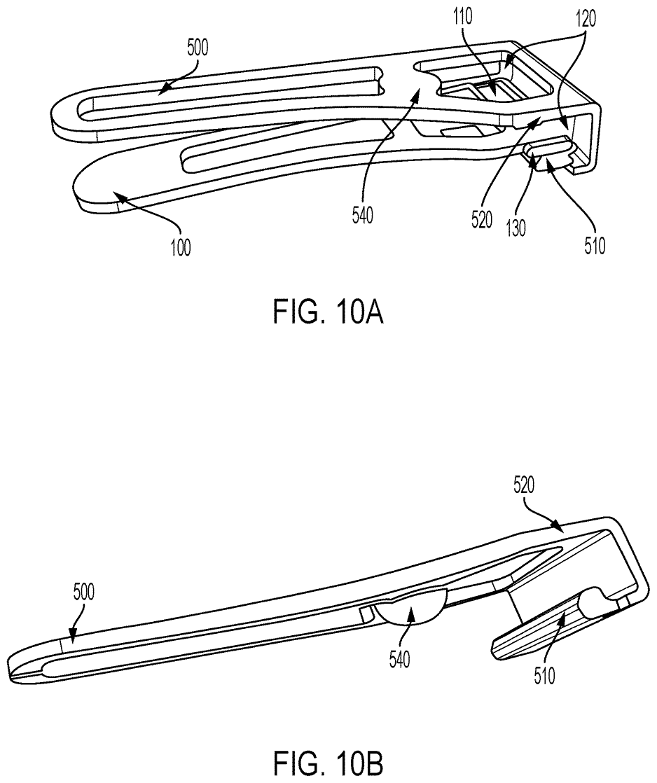

Sonic flow 81 as identified in FIG. 8 above the upper surface of the blade 50 encounters the corner 80 developed by the secondary clockwise vortex 84 which was developed by the lower flow 83 below the lower pressure surface of the blade 40 encountering the vortex inducer 60 front face and subsequently passing the apex 62 of the vortex inducer and separating, resulting in the primary vortex 87 which in this case has anticlockwise rotation.

The primary vortex 87 induces the secondary vortex 84 initially, from viscous coupling of the flow. The secondary vortex 84 then becomes the apex of the Prandtl-Meyer corner condition, resulting in the turning of the upper flow 81 through the Prandtl Meyer angle 87 and resulting in further acceleration of the upper exit flow 82 into the wake of the blade. The flow 82 induces further energising of the secondary vortex 84 and that feeds back to the primary vortex 87 in the region below the sonic flow condition 88. Where the secondary vortex 84 is established close to the trailing edge 30, but has a geometry that places the primary vortex 87 in front but below the secondary vortex core, periodic shedding as a von Karman vortex street is minimised or avoided, resulting in stable conditions, and increasing the average lift coefficient, reducing the drag coefficient, and minimising instability in lift, drag and pitching moment, resulting in lower vibration and improved performance of the blade.

Standard Prandtl-Meyer equations, never previously been applicable to propulsion may now be applied to: (i) the determination of the exit velocity of the wake; (ii) to the change in exit angle that occurs; (iii) the determination of the temperature and pressure in the wake following the expansion fan. By this manner, the normal shock has been removed completely from the upper surface of the blade (and wing if applied on a wing) and has been replaced with an isentropic, stable structure, the PMEF.

### Equations of Expansion Fan Flow

$$v ( {M}_{2} ) = v ( {M}_{1} ) + θ \qquad Equation 1$$

$$θ = v ( {M}_{2} ) - v ( {M}_{1} ) \qquad Equation 2$$

$${v}_{max} = \frac{π}{2} ( \sqrt{\frac{γ + 1}{γ - 1}} - 1 ) \qquad Equation 3$$

$$\frac{{T}_{2}}{{T}_{1}} = ( \frac{1 + \frac{γ - 1}{2} {M}_{1}^{2}}{1 + \frac{γ - 1}{2} {M}_{2}^{2}} ) \qquad Equation 4$$

$$\frac{{P}_{2}}{{P}_{1}} = {( \frac{1 + \frac{γ - 1}{2} {M}_{1}^{2}}{1 + \frac{γ - 1}{2} {M}_{2}^{2}} )}^{\frac{γ}{γ - 1}} \qquad Equation 5$$

| Case | C_{L} | C_{D} | C_{L}/C_{D} | Mcrit | D C_{L} | D C_{D} | D C_{L}/C_{D} |
|---|---|---|---|---|---|---|---|
| Standard | 0.504 | 0.055 | 9.165 | 0.556 | | | |
| Tabbed | 1.637 | 0.052 | 31.336 | 0.401 | 1.133 | −0.003 | 22.171 |

| | | | |
|---|---|---|---|
| Change as a percentage from Standard | 225% | −5.0% | 242% |

Table 1 above provides a calculated solution for a blade at a=3°, M=0.80, with a standard NACA 1403 airfoil, with and without a PMEF developing tab.

### Holder Tool

FIG. 8 shows a holder tool 100 that incorporates a recess 110 for locating the silicone mould insert in place, with the recess desirably incorporating a slight dovetail or undercut of the vertical sides to assist holding the insert in place. Alternatively double sided PSA tape may be used to maintain the inset in place during application. Tabs 120 are incorporated on the trailing edge end of the tool to permit the tool to be located correctly with appropriate offset from the trailing edge of the blade. These tabs also act to hold the tool, insert and adhesive clear of the blade until the tool has been located to the correct chord position. An offset edge 130 on the outer blade side of the tool sits against the fan shroud to locate the insert and adhesive at the correct spanwise location. In profile, the handle is bowed slightly to ensure the insert region 110 sits conformally to the pressure face of the blade.

### Compression Tool

FIG. 9 shows a compression tool that can be fabricated from polycarbonates, injection moulding of ABS, or by 3-D additive printing. As drawn, it is simplified, it will preferentially be curved at the compression head 530 to provide a uniform compressive force on the back face of the mould tool exterior. The handle 500 extends to be longer than the chord of the blade that is being modified. The width of the clamp offset 510 should permit locating the tool between the blades. The outboard edge of the tool 520 is wider than the main extent of the handle to ensure that it can contact the inside face of the fan shroud, to locate the tool radially along the blade. The handle between the outboard edge and the main handle has a reduced radial station to ensure that the edge at 520 contacts the shroud only. The inner edge of the handle indicated at 500 is preferentially curving away from the blade, to permit the fulcrum 540 to contact the suction face of the blade, and to then permit the compressing end of the tool 530 to force down on the mould holder tool outer face, thus achieving a compressive force onto the pressure face of the blade, of the adhesive held in the compression mould.

The handle ideally provides an area beyond the front edge of the blade 50 that the clip can press against to give a light tension across the fulcrum and the handle to lock the tool in place, thus holding the adhesive, mould, mould holder tool and the compression tool in place to permit a reliable bond to develop during curing.

### Energy Budgets

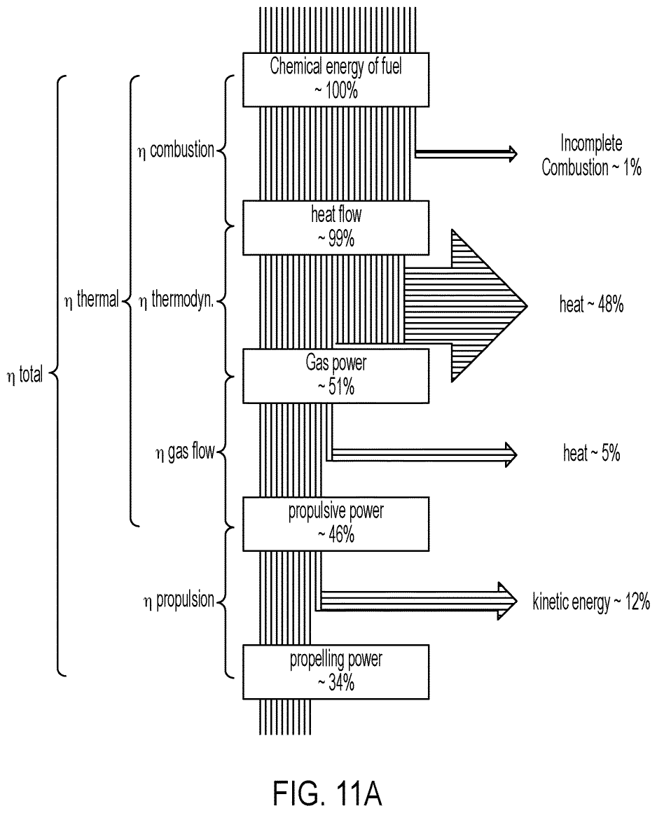

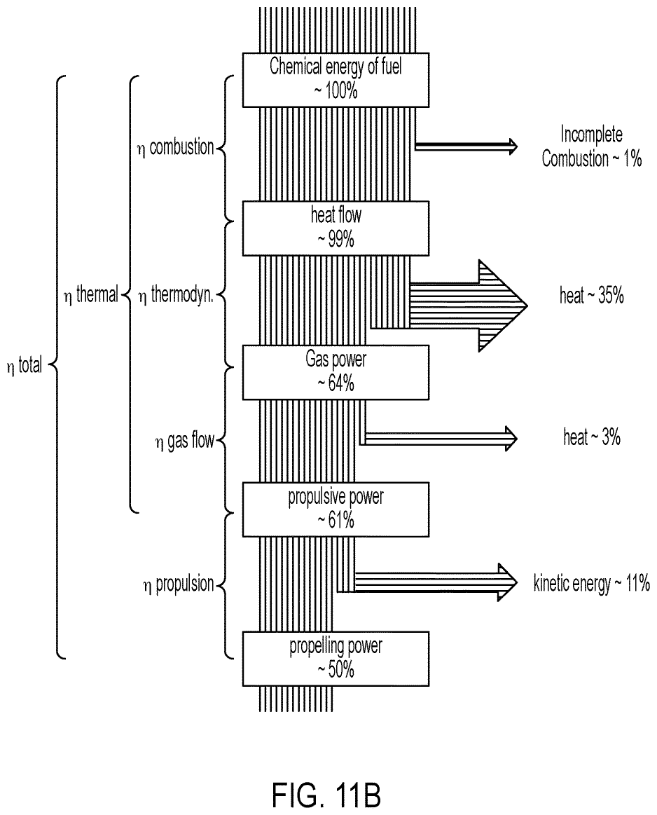

FIG. 11A shows a conventional energy budget. For the modified blade, a lower RPM achieves the standard thrust, but occurs for a lower fuel flow, and lower temperature of the combustion and turbine components. Additionally, lower RPM results in lower energy required to operate the compressor. It therefore follows that less heat flow losses occur, providing a greater percentage of chemical energy available for propulsion. This change occurs in the background and alters the apparent efficiency of propulsion.

FIG. 11B shows a modified engine energy budget wherein, as the engine is operating at a lower RPM and associated temperature, less energy is lost in the heat flow to atmosphere in the heat rejection of the engine components, and in the exhaust temperature above the inlet temperature.

As a direct result of the lower operating temperature and associated heat flow losses, more energy is available to apply to propulsive (61%/48%), and to propelling power (50%/34%) as shown in this example.

### Circumventing Mass Flow Rate Choking in a Duct

Conventional assumptions are flow accelerates in a convergent duct, with pressure reducing commensurately, and the opposite occurs in a divergent duct. This follows Bernoulli theory. For supersonic flow conditions, the opposite occurs, and a convergent duct with supersonic flow in will decelerate, and the pressure will increase, and the opposite occurs for the divergent supersonic case.

The technology of the fan blade modification brings this behaviour to importance, as velocity in the fan blade exit has previously been subsonic, and the behaviour of the flow is assumed to be subsonic by design, the current art turbomachinery design software precludes any flow occurring in the engine at or above Mach 1 as mass flow rate choking is expected to occur.

The consequence of achieving an exit velocity from the fan blade trailing edge that is supersonic is to send flow at supersonic velocity into the standard duct of the engine.

### Duct Types in a Turbofan Engine

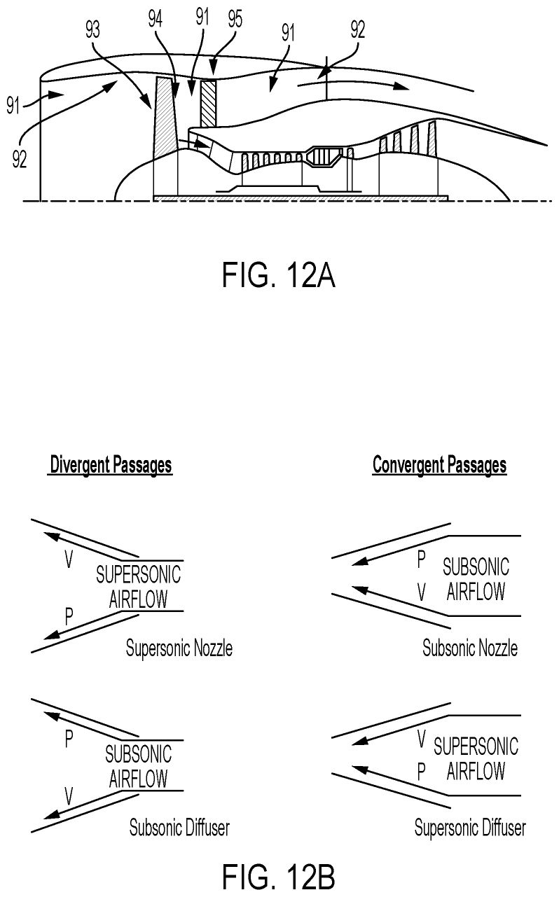

FIG. 12A presents the geometry of intake and bypass ducts in a generic high bypass turbofan engine with unmixed bypass/core nozzles.

The intake is convergent, the nacelle then is divergent to the fan face 93 and the flow then enters a convergent duct to the stator 95 then is convergent until approaching the nozzle, where it is divergent at the exit to atmospheric. Convergent conditions are shown as 91, divergent as 92. The flow at the exit of the fan 94 is normally subsonic, however the effect of the invention on the blade is that it will result in sonic flow conditions at the exit of the fan blade.

As indicated in FIG. 12B, the effect on velocity and pressure from a duct that alters area between stations is reversed for supersonic flow compared with subsonic conditions. The design criteria applied to give the standard engine stable flow through the duct is consistent with the supersonic conditions that will maintain flow supersonic to the exit nozzle, where exit flow from the fan blade has achieved sonic velocity.

This characteristic of flow in ducts circumvents mass flow rate choking that would otherwise occur where the flow off the back of the fan is subsonic.

1. A system for enhancing the efficiency of a propulsion rotor blade, the system comprising a propulsion rotor blade defining a pressure face and a suction face, wherein a vortex inducer is applied to the pressure face of the blade, wherein:
the vortex inducer defines an aft face;
the aft face is located forward of a trailing edge of the blade, and wherein, in use, the vortex inducer is configured such that:
the aft face separates flow to induce a primary vortex behind an apex of the aft face,
the primary vortex induces a counterrotating secondary vortex through viscous coupling at the trailing edge of the blade,
the secondary vortex rotates tangential to the trailing edge to:
accelerate suction face wake and to deflect the suction face wake; and
further deflect the suction face wake away from the trailing edge.

2. A system as claimed in claim 1, wherein the secondary vortex accelerates the suction face wake from the blade thereby causing the normal shock wave to translate to the trailing edge where the normal shock wave is replaced by an isentropic expansion fan thus further increasing the velocity of the suction face wake.

3. A system as claimed in claim 1, wherein the vortex inducer defines a tapered profile, with the height of the vortex inducer increasing progressively towards the aft face.

4. A system as claimed in claim 1, wherein the blade defines a blade chord and wherein the vortex inducer defines a height of between 0.25% and 2% of the blade chord.

5. A system as claimed in claim 1, wherein a distance between the aft face and the trailing edge is between 50% and 500% of a height defined by the vortex inducer.

6. A system as claimed in claim 1, wherein the vortex inducer defines an apex with a height, and the distance between the trailing edge of the blade and the aft face of the vortex inducer is proportionate to the height of the apex.

7. A system as claimed in claim 1, wherein the vortex inducer is attached to the pressure face along a span of the blade between 0.6 to 0.95 of the blade radius.

8. A system as claimed in claim 1, wherein the vortex inducer's height varies in relation to the chord length at different radial positions.

9. A system as claimed in claim 1, wherein the vortex inducer defines an outer face that is at least one of linear and ogive in shape.

10. A system as claimed in claim 1, wherein suction face airflow is subsonic, and the secondary vortex accelerates the suction face wake to supersonic speeds.

11. A system as claimed in claim 10, wherein the suction face wake energises the secondary vortex which further energises the primary vortex through viscous coupling.

12. A system as claimed in claim 1, wherein the blade is at least one of a propeller, lift rotor, prop rotor, quad rotor and inducted fan blade.

13. A system as claimed in claim 1, wherein the blade is a fan blade.

14. A system as claimed in claim 1, wherein the blade is a marine propeller.

15. A system as claimed in claim 1, wherein the vortex inducer attaches to tape bonded to the pressure face.

16. A system as claimed in claim 15, wherein hook and loop fasteners connect the vortex inducer to the tape.

17. A system as claimed in claim 1, wherein the vortex inducer is moulded from mouldable material bonded to the pressure face.

18. A system as claimed in claim 17, wherein the mouldable material comprises a thermosetting resin.

19. A system as claimed in claim 18, wherein the thermosetting resin comprises epoxy resin.

20. A system as claimed in claim 17, wherein the thermosetting resin is cured in a single curing process, resulting in a single bond line between the vortex inducer and the pressure face.

21. A system as claimed in claim 1, further comprising a holder tool defining a recess configured for holding a mould for the vortex inducer.

22. A system as claimed in claim 21, further comprising a compression tool configured to compress the holder tool against the pressure surface.

23. A system as claimed in claim 22, wherein the compression tool comprises a compression head configured to pass behind the trailing edge of the blade on insertion from the suction face of the blade, and extend around the rear of the blade to contact an outer face of the holder tool.

24. A system as claimed in claim 22, wherein the compression tool defines a handle and a fulcrum protrusion on an inner edge of the handle that is configured to press against the suction face by leverage applied from a proximal end of the handle.

25. A system as claimed in claim 1, further comprising a turbofan engine comprising the blade, the turbofan engine defining a bypass duct and an exit nozzle, wherein duct velocity between the bypass duct and the exit nozzle is subsonic.

26. A system as claimed in claim 25, wherein the exit nozzle is a mixed flow nozzle.

27. A system as claimed in claim 25, wherein the exit nozzle is an unmixed flow nozzle.

28. A system as claimed in claim 25, further comprising a thrust lever controlling the turbofan engine, wherein a restrictor restricts operation of the thrust lever to maximum thrust.

29. A system as claimed in claim 28, wherein the restrictor incorporates a user-selectable lever motion limiting gate.

30. A system as claimed in claim 29, wherein the lever motion limiting gate can be opened by force.

31. A system as claimed in claim 30, further comprising an alert output device operably coupled to the lever motion limiting gate and configured to generate an alert when the lever motion limiting gate is opened by force.

32. A method of enhancing the efficiency of a propulsion rotor blade, the method comprising:
applying a vortex inducer to a pressure face of the blade, the vortex inducer defines an aft face located forward of a trailing edge of the blade, the vortex inducer configured to:
induce a primary vortex behind an apex of the aft face by the flow separation caused by the vortex inducer; and
induce a counterrotating secondary vortex through viscous coupling with the primary vortex at the trailing edge of the blade to accelerate and deflect suction face wake by the secondary vortex and deflect the suction face wake further away from the trailing edge.

33. The method as claimed in claim 32, wherein the secondary vortex accelerates the suction face wake from the blade thereby causing the normal shock wave to translate to the trailing edge where the normal shock wave is replaced by an isentropic expansion fan thus further increasing the velocity of the suction face wake.

34. The method as claimed in claim 32, further comprising accelerating the suction face wake to supersonic speeds using the secondary vortex.

35. The method as claimed in claim 34, further comprising energising the primary vortex by the suction face wake through viscous coupling with the secondary vortex.

36. The method as claimed in claim 32, wherein the blade is selected from the group consisting of a propeller, a helicopter rotor, a prop-rotor, a fan blade, and a marine propeller.

37. The method as claimed in claim 32, further comprising bonding the vortex inducer to the pressure face using a tape.

38. The method as claimed in claim 37, wherein the vortex inducer comprises at least one of looped, knitted and woven material.

39. The method as claimed in claim 32, wherein the vortex inducer is moulded from a thermosetting resin and bonded to the pressure face in a single curing process.

40. The method as claimed in claim 39, wherein the thermosetting resin comprises epoxy resin.

41. The method as claimed in claim 32, further comprising positioning a holder tool with a recess for holding a mould for the vortex inducer against the pressure face of the blade.

42. The method as claimed in claim 41, further comprising compressing the holder tool against the pressure surface using a compression tool.

43. The method as claimed in claim 42, further comprising inserting the compression tool behind the trailing edge of the blade from the suction face and leveraging the compression tool to compress the holder tool against the pressure face.

44. The method as claimed in claim 32, further comprising controlling a turbofan engine comprising the blade using a thrust lever with a restrictor to limit maximum thrust output.

45. The method as claimed in claim 44, further comprising using a lever motion limiting gate as part of the restrictor, wherein the gate can be selectively opened by force to allow increased thrust.

46. The method as claimed in claim 45, further comprising generating an alert using an alert output device when the lever motion limiting gate is opened by force.

47. The method as claimed in claim 43, further comprising accelerating the suction face wake to supersonic speeds to reverse bypass duct behaviour due to the convergent duct being supersonic to avoid a mass flow rate choked condition in a turbofan engine.
